(19) United States
(12) Patent Application Publication
(10) Pub. No.: US 2009/0122205 A1
(43) Pub. Date: May 14, 2009

(54) Method and Apparatus for Performing a Channel Search

(75) Inventors: Mike Xing, Fishers, IN (US); Dale Wayne King, Noblesville, IN (US)

Correspondence Address: Robert D. Shedd;Thomson Licensing LLC, PO Box 5312, PRINCETON, NJ, 08543-5312, US

(73) Assignee: Joseph J. Laks Thomson Licensing LLC, Princeton, NJ (US)

(21) Appl. No.: 12/085,410

(22) PCT Filed: Nov. 29, 2005
(86) PCT No.: PCT/US2005/042930

§ 371 Date: May 21, 2008

(51) Int. Cl. H04N 5/50

(52) U.S. Cl. 348/732; 348/E05.097

(57) ABSTRACT

A receiver, such as an HDTV receiver or a Personal Video Recorder (PVR), includes a plurality of tuners. Each tuner is adapted to receive television signals (RF1,RF2) comprising a plurality of channels and communicate the received television signals to a processor. A channel search or autoprogramming routine is disclosed for the detection of channels in the television signal wherein each tuner simultaneously tunes and interrogates a different channel in order to expedite the search. If a signal is not detected on a channel, that channel may be tuned and interrogated by a second tuner. A list is compiled of all the channels that contain a television signal to aid the viewer's selection.

### FIELD OF THE INVENTION

The present invention relates to television signals and, more particularly, to the search and detection of television signals, particularly digital HDTV signals.

### BACKGROUND OF THE INVENTION

Television receivers and other equipment such as set-top boxes must be able to receive digital and analog signals and typically to perform an autoprogramming search to determine the channels that are available on any particular input source. In many instances, such receivers and other digital/analog equipment may have two or more tuners that are adapted to receive various signal sources. These multiple tuner receivers may be configurable to allow each tuner to select the same or different channels from a common input source. Two examples of receivers wherein the capability to tune channels from a common signal input are receivers having a picture-in-picture capability and receivers having a capability to simultaneously view and record different channel audio and video signals. Such a simultaneous view and record capability is often called a Personal Video Recorder.

Digital and analog television signals may be received from sources such as antennas, community cable systems, Direct Broadcast Satellite (DBS) systems, or the like and often offer numerous channels. The large number of possible channels necessitates compilation of an available channel list, i.e., a subset of the list of all the possible channels, wherein the subset contains only the available channels. Available channels means channels which contain signals. Use of such a list of available channels allows the receiver to skip those channels that do not carry programming when the user is switching between the various channels. Channel autoprogramming algorithms and systems for automatically detecting active channels and indicating the active channels in a channel scanning list are known for television receivers.

It is known to provide a channel search routine for channels that will obtain a discrete sample or “snapshot” of all the currently available channels on all of the various signal inputs. The channel search routine then stores all of the channels detected from all of the signal inputs during the search in memory (e.g. EEPROM), deleting any channels previously stored that are not now currently available. At power-up of the unit, the channels in EEPROM become the channel list. This may occur when the user makes an adjustment to the antenna, such as moving position or location, or when the DBS or cable system adds and/or deletes channels. With the ever increasing number of possible channels in a given area, conventional channel search procedures have caused the time required for receivers to accomplish their “auto-program” to become longer. With the proliferation of digital television, the time required to auto-program has become even longer, due to the relatively longer time required to tune and decode digital television channels compared to analog channels. As a result there is a need for shortening the channel search time required to perform the auto-program function.

### SUMMARY OF THE INVENTION

In accordance with one aspect of the present invention, there is provided a method for performing a channel search on a television having multiple tuners, the method comprises determining a first set of possible channels on a first signal input, determining a second set of possible channels on a second signal input, detecting available channels from the first set of possible channels on a first of the two tuners, detecting available channels from the second set of possible channels on a second of the two tuners and adding channels that are not detected as available channels using said second tuner to said first set of possible channels to be detected using said first tuner. The method may also comprise compiling a list of available channels from both tuners. In an embodiment wherein the tuners have dissimilar characteristics, channels that are not available channels from the one tuner having significantly lower performance are added to the set of possible channels to be detected by the tuner of having significantly better performance characteristics. Another embodiment of the present invention is an apparatus comprising a first tuner for tuning a first set of possible channels, a second tuner for tuning a second set of possible channels, means for detecting available channels from the first set of possible channels, means for detecting available channels from the second set of possible channels and a controller for adding channels that are not available channels tuned by said second tuner to said first set of possible channels for said first tuner. In an alternative apparatus embodiment wherein the second tuner has significantly lower sensitivity than the first tuner, channels that are not available channels from the second tuner are added to the set of possible channels for the first tuner.

### BRIEF DESCRIPTION OF THE DRAWING

The above-mentioned and other features and advantages of this invention, and the manner of attaining them, will become more apparent and the invention will be better understood by reference to the following description of an embodiment of the invention taken in conjunction with the accompanying drawing, wherein:

FIG. 1 is a block diagram of a system adapted to receive and utilize digital and analog television signals, as well as perform various television channel searches and storage of channel lists for various inputs;

FIG. 2 is an alternative system adapted to receive and utilize digital and analog television signals, as well as perform various television channel searches and storage of channel lists for various inputs;

FIG. 3 is another alternative system adapted to receive and utilize digital and analog television signals, as well as perform various television channel searches and storage of channel lists;

FIG. 4 is a flow chart describing one embodiment of the present invention; and

FIG. 5 is a flow chart describing another embodiment of the present invention.

Corresponding reference characters indicate corresponding parts throughout the several views. The exemplification set out herein illustrates a preferred embodiment of the invention, and such exemplification is not to be construed as limiting the scope of the invention in any manner.

### DETAILED DESCRIPTION OF THE INVENTION

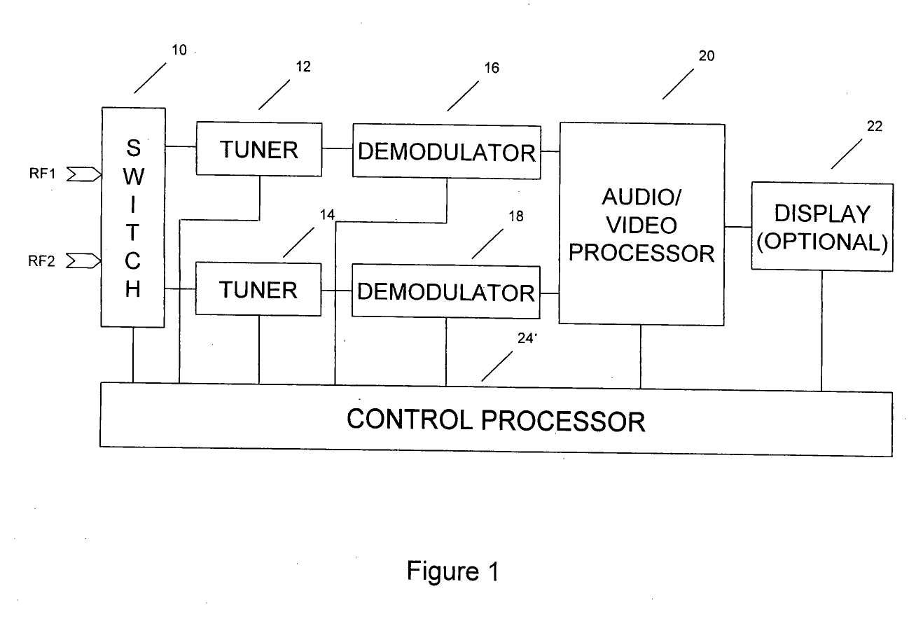

Referring now to the drawings and, more particularly to FIG. 1, there is shown a simplified, functional block diagram of a receiver system. The receiver system of FIG. 1 may portray a television receiver or a display device and DBS and/or set-top box receiver. Input signals RF1 and RF2 are applied to an input selector switch 10. Selector switch 10 may apply any of several radio frequency (RF) inputs to tuners 12 and 14. In this embodiment, either tuner may receive an input signal from any of several sources, for example a cable source and an antenna source, or tuners 12 and 14 may be switched to receive the same RF signal input. The output of each tuner is connected to demodulators 16 and 18 for decoding of the respective signals. Demodulators 16 and 18 supply decoded audio and video program material to audio/video processor 20, which in turn sends signals to a display device 22. Display 22 may include audio loudspeakers and any of several types of visual displays. Control processor 24 connects to each of the aforementioned blocks and provides control, memory and user interface functions. Control processor 24, among its other tasks, provides tuning instructions to tuners 12 and 14 and receives information from demodulators 16 and 18 which is indicative of the presence of a signal having been received by its respective tuner. Control processor 24 also maintains a channel list in its memory which is developed during an “autoprogram” sequence, often performed the first time a receiver is turned on after having power applied. In operation, the “autoprogram” sequence is conducted by having the tuner(s) tune to each possible channel within its tuning range with the respective demodulator sending information to control processor 24 whether a signal is available for each possible channel. Contol processor 24 compiles a list of available channels so that a viewer may scan only available channels. As mentioned previously, autoprogramming can take a considerable amount of time, particularly if digital channels are being tuned. The system shown in FIG. 1 and employing an embodiment of the present invention can expedite autoprogramming by utilizing both tuners operating simultaneously with control processor 24 compiling a common channel list. If only one RF source is to be “autoprogrammed”, switch 10 may apply that RF source to both tuners. If tuners 12 and 14 are of similar design and are of similar sensitivity, autoprogramming time can be essentially halved by simultaneously tuning each tuner to alternate possible channels. In some receivers the tuners are of dissimilar sensitivity. This is often the case when one tuner is primarily used for a small inset picture in a picture-in-picture feature. In this case the lower sensitivity tuner may not detect the presence of a signal that the more sensitive tuner would detect. In such an instance the autoprogramming may proceed as described above, except that possible channels for which the lower sensitivity tuner does not find an available signal need to be verified by having the possible channel added to the list of possible channels to be tuned by the higher sensitivity tuner. Autoprogramming in this instance would not be as fast as in the previous example, but would still be expedited by the present invention.

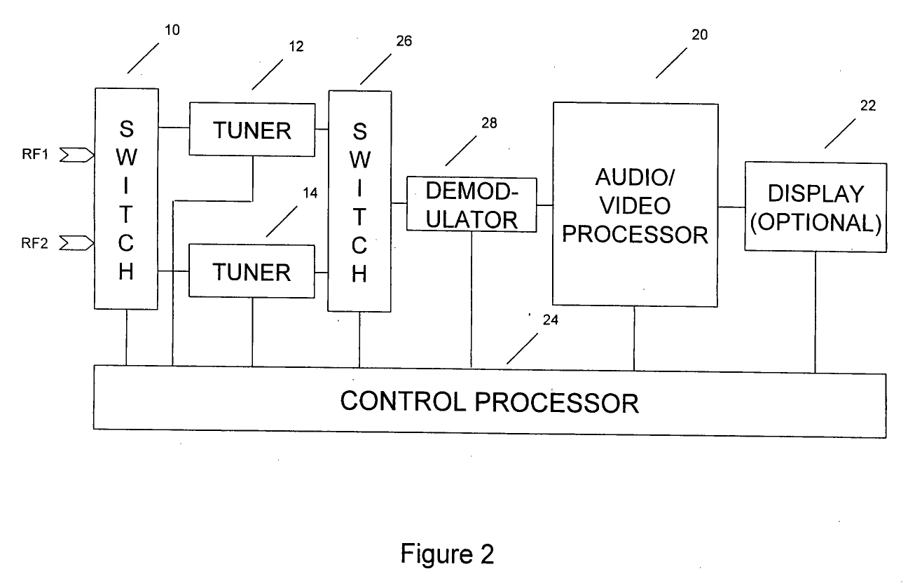

In the block diagram shown in FIG. 2, only one demodulator 28 is used and its input is switched between the output of tuner 12 and tuner 14 by switch 26. An embodiment of the present invention is also useful in a receiver of this configuration; however the time reduction in autoprogramming would be further reduced. Demodulator 28 decodes one tuner output and detects if this tuner has acquired an available channel during the time that the other tuner is acquiring a new possible channel. Otherwise, operation of autoprogramming according to the present invention is similar to that described previously.

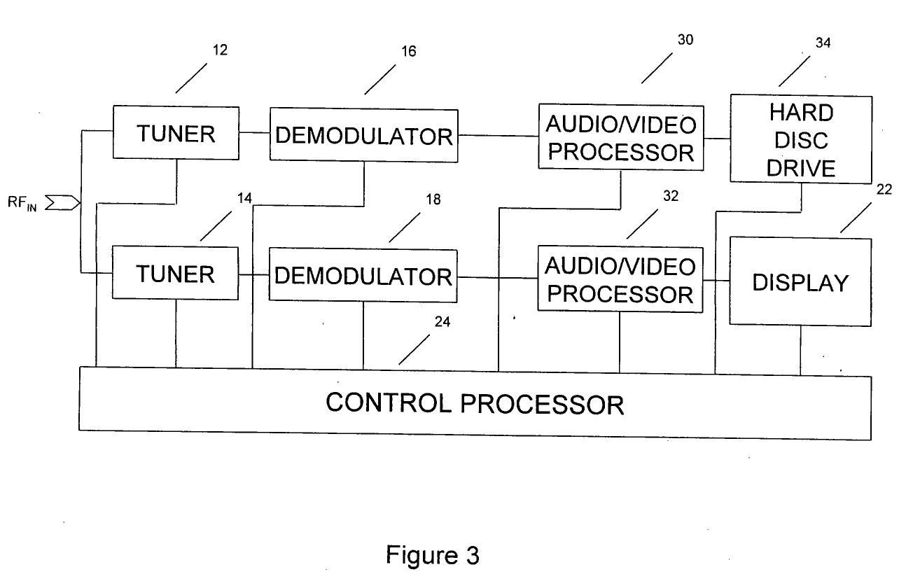

FIG. 3 shows a block diagram of a system often referred to as a Personal Video Recorder (PVR). FIG. 3 is shown as having one RF input (RF_{IN}), although it could also have multiple RF inputs as described in connection with FIGS. 1 and 2. Each demodulator 16 or 18 in FIG. 3 supplies decoded signals to separate audio/video processors 30 or 32, with one program being supplied to a hard disc drive 34 for recording while a second audio/video processor provides signals to display 22. In this system, the present invention is also beneficial for expediting autoprogramming.

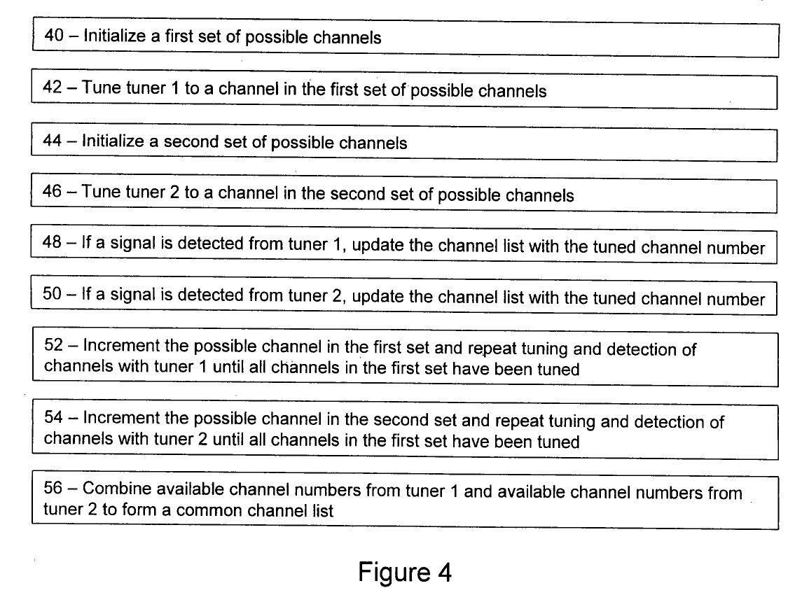

FIG. 4 describes a method of practicing an embodiment of the present invention wherein the tuners each have similar ability to tune and retrieve signals from a channel, usually because of similar sensitivity. The method of FIG. 4 begins in step 40 by initializing a first set of possible channels. The next step 42 is to program tuner 1 to a possible channel in the first set of possible channels. The above steps are repeated as steps 44 and 46 for a second set of possible channels to be tuned by tuner 2. In step 48 a determination is made if the possible channel tuned by tuner 1 is also an actual channel, in which case the channel number is added to the channel list in memory. Step 50 involves a similar detection and addition to the channel list for available channels from tuner 2. In step 52 the possible channel number in the first set of possible channels is incremented and steps 40, 42 and 48 are repeated until all the channels in the first set of possible channels have been tuned and detected by tuner 1. Step 54, increments the channels in the second set of possible channels and repeats steps 44, 46 and 50 until all the channels in the second set of possible channels have been tuned and detected by tuner 2. In step 56, a common channel list is compiled containing all the available channels from either tuner.

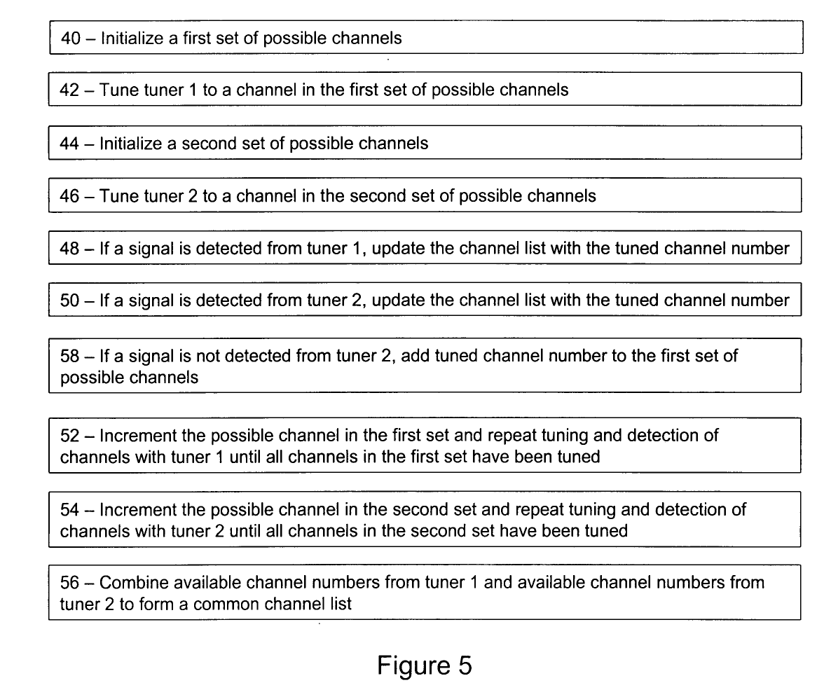

The method described in FIG. 5 details the steps of an embodiment of the invention wherein tuner 2 has significantly lower sensitivity than tuner 1. the steps in FIG. 5 are similar to steps in the method of FIG. 4 for instances where the presence of a signal is detected from either tuner. An additional step 58 is included in FIG. 5 for the case that an actual channel is not detected from tuner 2. In step 58 the possible channel on which tuner 2 could not detect a signal, is added to the first set of possible channels to be tuned by tuner 1.

While this invention has been described as having a preferred design, the present invention can be further modified within the spirit and scope of this disclosure. This application is therefore intended to cover any variations, uses, of adaptations of the invention using its general principles. Further, this application is intended to cover such departures from the present disclosure as come within known or customary practice in the art to which this invention pertains and which fall within the limits of the appended claims.

What is claimed is:

1. In an apparatus having two tuners, a method of performing a channel search comprising:
detecting a first set of available channels from a first set of possible channels using a first of said two tuners;
detecting a second set of available channels from a second set of possible channels using a second of said two tuners; and
detecting as possible channels using said first tuner that are not detected as available channels using said second tuner.

2. The method of claim 1 further comprising Compiling a list of channels available from each of said two tuners.

3. The method of claim 1 wherein said two tuners have essentially the same characteristics.

4. The method of claim 1 wherein said first of said two tuners has significantly better performance characteristics than said second of said two tuners.

5. The method of claim 4 wherein channels that are not available channels using said first of said two tuners are not added to said possible channels of said second of said two tuners.

6. The method of claim 1 wherein said first signal input is the same as said second signal input.

7. An apparatus, comprising:
a first tuner for tuning to a first set of possible channels;
a second tuner for tuning to a second set of possible channels;
a detector for determining available channels tuned by said first set of possible channels and for determining available channels tuned by said second set of possible channels; and
a controller for tuning as possible channels by said first tuner channels that are not available channels tuned by said second tuner.

8. The apparatus of claim 7 wherein said first and said second tuners receive the same signal.

9. The apparatus of claim 7 further comprising a list of available channels available from said first tuner and said second tuner.

10. The apparatus of claim 7 wherein said first tuner and said second tuner have essentially the same sensitivity.

11. The apparatus of claim 7 wherein said second tuner has significantly lower sensitivity than said first tuner.

12. The apparatus of claim 11 wherein channels that are not available channels from said first set of possible channels are not added to said second set of possible channels.

13. An apparatus, comprising:
means for detecting the available channels in a first set of possible channels;
means for detecting the available channels in a second set of possible channels;
means for compiling a list comprising available channels in said first set of possible channels and available channels in said second set of possible channels; and
means for adding channels that are not available channels in said second set of possible channels to said first set of possible channels.

14. The apparatus of claim 13, wherein said means for detecting the available channels in a first set of possible channels and said means for detecting the available channels in a second set of possible channels have essentially the same detecting sensitivity.

15. The apparatus of claim 13, wherein said means for detecting the available channels in a second set of possible channels has a lower detecting sensitivity than said means for detecting the available channels in a first set of possible channels.

16. The apparatus of claim 15, wherein channels that are not available channels in said first set of possible channels are not added to said second set of possible channels.
